(19) United States
(12) Patent Application Publication
(10) Pub. No.: US 2023/0143125 A1
(43) Pub. Date: May 11, 2023

(54) PROCESS FOR PRODUCING PUMPKIN SEED MILK

(71) Applicant: Julio Cesar Duarte Carranza, Ciudad de Guatemala (GT)

(72) Inventor: Julio Cesar Duarte Carranza, Ciudad de Guatemala (GT)

(21) Appl. No.: 17/519,890

(22) Filed: Nov. 5, 2021

(51) Int. Cl. A23C 11/10; A23B 9/08

(52) U.S. Cl. CPC A23C 11/103; A23B 9/08

(57) ABSTRACT

A process for preparing a pumpkin seed milk or beverage is described, while keeping controlled seed dehydration conditions that maintain the color, flavor and, especially, the nutrients of the pumpkin seeds, that leverages most of the seeds, facilitates milling and provides high yield. Furthermore, the furnace and mill specifically designed to carry out the process for preparing the pumpkin seed beverage are described.

### TECHNICAL FIELD OF THE INVENTION

The present application relates, in general, to the field of food production; particularly to the production of a pumpkin seed derived protein beverage.

### BACKGROUND OF THE INVENTION

It is known that pumpkin seeds can be used for the production of healthy, protein-rich beverages; however, numerous problems have been identified with conventional processes. For example, oxidation of flavor, loss of nutrients, poor appearance of the product, as well as waste problems during the process have been identified.

Traditional processes for preparing beverages derived from vegetable seeds usually include the step of roasting the seed, such as in the process described in CN103190488A; however, roasting is an oxidative process that may introduce undesirable colors and flavors, as well as loss of nutrients, which is problematic for a beverage for human consumption. The problems of heat treatment have been recognized and there have been attempts to solve the problems generated by heat denaturation of the pumpkin seed protein. For example, CN105054164A describes a process in which a method for milling pumpkin seeds with warm water is adopted in an effort to obtain a beverage with a satisfactory mouthfeel while avoiding heat denaturation. The described process comprises the steps of: 1) cleaning dry pumpkin seed products; 2) grinding the cleaned dry pumpkin seed products into pulp; 3) separating the pulp from dregs so as to obtain serosity; 4) emulsifying the serosity, an emulsifying agent, a protein stabilizing agent and a dietary alkali so as to obtain feed liquid; 5) dissolving sugar so as to obtain syrup; 6) compounding the emulsified feed liquid with the syrup so as to obtain a pulp material; 7) filtering the pulp material; 8) pouring the filtered pulp material into a container, and sealing the container; and 9) performing high-pressure sterilization. However, this process involves the addition of several additives, such as sugar, protein stabilizing agents, and emulsifiers; therefore, there is still a need to improve the processes for obtaining a beverage with a high nutritional content and free of additives.

CN102613641 discloses a process including the steps of: a) selecting and removing impurities, b) soaking pumpkin seeds, c) cooking, d) removing the endothelium, e) refining by milling, f) separating and removing residues, g) adding sweetener, h) dissolving emulsifier, i) formulation and mixing, j) homogenization, k) filling and l) sterilization. However, in the step of separating and removing residues, the ground pumpkin seed suspension is passed through a centrifuge where the protein in suspension is separated and recovered, generating a huge amount of bagasse waste, with the consequent loss of nutrients and natural fiber. Another problem associated with this process is—again—the use of added sugars and several additives in the beverage.

Based on the foregoing, there is a need for an optimized method for the production of a pumpkin seed based beverage also known as pumpking seed milk, which reduces waste, limits or eliminates the need to use sweeteners, emulsifiers and other additives, addresses the negative impact of the oxidative process without modifying the texture, color, flavor and, especially, its nutrients.

### BRIEF DESCRIPTION OF THE INVENTION

The present invention therefore seeks to provide a process for the transformation of pumpkin seeds into a beverage that is produced in a controlled environment so as to maintain the properties of the seed, that does not require additives, that uses whole seeds, which maintains all nutrients and natural fiber, which facilitates milling and has a high yield.

According to a first aspect of the invention, there is provided a method for producing a beverage or milk from whole pumpkin seeds, comprising the steps of:

a) sorting a seed;

b) peeling and germinating the seed;

c) dehydrating or drying the seed;

d) sorting the seed;

e) UV disinfection;

f) milling the seed and preparing a concentrate;

g) formulation and mixing the pumpkin seed beverage, free of additives; and

h) packaging the pumpkin seed beverage.

In the method provided by the present invention, the pumpkin seed dehydration and milling technique was developed and specialized for the successful extraction of all nutrients from the pumpkin seed and the maximum use thereof, without generating waste. In this technique, the seed goes through a transformation process from which a pumpkin seed beverage concentrate is obtained, starting with dehydration until it reaches milling.

In one embodiment of the process, a second drying process can be carried out, prior to UV disinfection, to guarantee the flavor and extraction of healthy oils. It is also possible to perform a double milling step at high speed for a higher nutrient extraction.

In a second aspect of the invention, a furnace that allows the drying process to be carried out in a controlled environment is provided. In order to achieve the precise result in the seed, a moisture extracting furnace was designed and manufactured. This self-design furnace was specially manufactured for the pumpkin seed drying or dehydration process, which allows the seed to reach a humidity range between 1.90% and 5.5%, without roasting it, without modifying its texture, color, flavor and, especially, its nutrients.

In a third aspect of the invention, a colloid mill having a water cooling system is provided so that the pumpkin seed does not heat up or alter its color, flavor and nutritional values.

### BRIEF DESCRIPTION OF THE DRAWINGS

The enclosed figures illustrate some of the aspects provided in the present invention.

FIG. 1 represents a side perspective view of a moisture extracting furnace according to the present invention;

FIG. 2 represents a rear internal view of the furnace of FIG. 1;

FIG. 3 represents a front internal view of the furnace of FIG. 1; and

FIG. 4 represents a colloid mill according to the present invention.

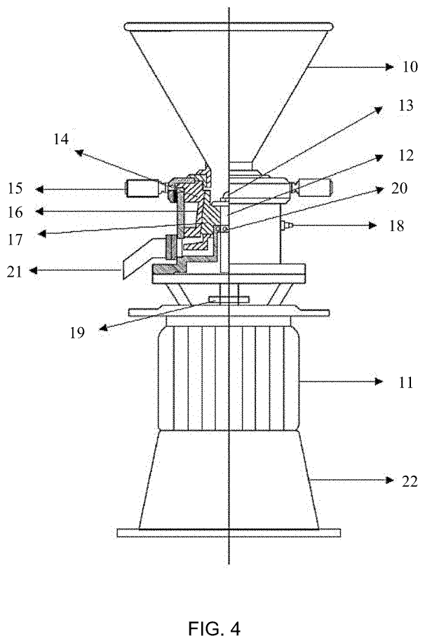

It should be understood that the figures show an exemplary embodiment and other embodiments may properly fall within the scope of the claims.

A detailed description of an exemplary embodiment of the present invention is provided below. It is to be understood, however, that the invention is not to be construed as limited to this embodiment.

### DETAILED DESCRIPTION OF THE INVENTION

In a first embodiment of the present invention a method for obtaining a pumpkin seed based beverage or pumpkin seed milk is provided, the method comprises the steps of:

a) sorting a seed used as raw material;

b) peeling and germinating the seed;

c) dehydrating/drying the seed;

d) sorting the dehydrated seed;

e) UV disinfection;

f) milling the seed and preparing a concentrate;

g) formulation and mixing the pumpkin seed beverage, free of additives; and

h) packaging the pumpkin seed beverage.

In an exemplary embodiment, the process further envisages an initial step of receiving raw material in which the pumpkin seed is received in an area intended for such purpose, where it must go through qualitative analysis controls for determining the quality of the raw material. Furthermore, the weight of the raw material is verified and it is optionally stored. In order for the seed to be used in the preparation of the pumpkin seed based beverage, it must comply with a moisture percentage of less than 12% and an aflatoxin content of less than 10 PPB. If the results do not comply with these parameters, the batch of raw material is rejected, if the results comply with these parameters, they are stored in the raw material warehouse.

In a preferred embodiment of the invention, the step of sorting the pumpkin seed used as raw material is carried out in a seed sorting machine which is fed through the hopper, to then be dosed into the vibrating densimetric cylinder, which removes organic matter whose density is greater than that of the raw material itself. Optionally, a double process of vibrating, blowing and sieving is carried out to finish the separation and removal of the contaminants present in the batch of raw material. Subsequently, a size sorting is carried out using vibrating sieves and the clean seed is stored; for example, in polypropylene bags.

For a better control of the process, it is possible that, at the end of the sieving process, weighing is carried out to verify the total of sorted seeds and the total of residues or contaminating material, to be later transferred to the warehouse of sorted product.

In the step of peeling the seed, an alkaline aqueous solution is used, preferably a solution with calcium hydroxide (CaOH) is used at a concentration of 3.16 g/L at a pH between 10 and 12. The seed is soaked for a period between 3 and 15 minutes, in the calcium hydroxide solution, optionally jute bags are used to carry out the soaking. In this step, the correct extraction of the shell is guaranteed, also called exocarp or husk, without affecting the green membrane characteristic of the seed. During soaking, calcium hydroxide works as an alkalinizer, removing mineral and organic impurities, and preventing bacterial proliferation. At the end of the soaking, the bags are removed and distillation is carried out.

To carry out the peeling of the seed, the product is gradually placed in the feeding hopper of the specialized pumpkin seed peeling machine. By means of the elevator buckets of the machine, the seed is transferred to the peeling blades, separating the seed from the shell, then these fall into a sieve in which the shell is sucked by the separating blower. When finished, the total seed and resulting shell are weighed.

In order to enhance the availability of the nutrients, the peeled seed is left to germinate for a period of 12 to 24 hours in filtered and purified water with UV. At the end of the period, the distillation is carried out.

Among the critical steps of the process according to the present invention are the steps of dehydration and milling of the pumpkin seed, which are carried out by means of a specialized and controlled technique for the successful extraction of all the nutrients and the maximum use of the seed, without generating waste.

In the dehydration step, the seed is subjected to a drying, dehydration and disinfection process at high temperatures, which is carried out in a moisture extracting furnace specifically developed for this step of the process and which consists of a second aspect provided by the present invention and whose components will be described with more detail below. This dehydration step allows the seed to reach a moisture range between 1.90% and 5.5%. It is important to note that under these conditions, the seed is not roasted, and the texture, color or flavor is not modified, in addition that it preserves all the nutrients.

In greater detail, the seed drying/dehydrating process comprises the steps of:
i) Seed palletizing: After the seed has been peeled and germinated, it is placed in trays where it is prepared to be fed into the furnace;
ii) Seed Baking: The seed is placed into the moisture extracting furnace and left there for 1 to 6 hours, until it reaches a temperature between 110 and 120° C., then the seed is left at said temperature for an additional 20 to 60 minutes;
iii) Moisture Balance Control: Samples are taken from the baked seed and it is verified that the moisture percentage is between 1.90% and 5.5%; and
iv) Weighing: At the end of the baking process, the seed is reweighed.

The dehydrated seed sorting step is carried out by means of a sorter machine, for this, the seed is placed in the machine that performs a high-precision sorting, completely discarding the seed with aflatoxin, brown and white seeds, and any undesirable residue or foreign material (lumps, husk and others) that could be present in the seed that has undergone the dehydration step. When finished, it is weighed again to verify the amount of sorted seeds.

The seed selected from the dehydrated seed sorting step is placed in a UV disinfection machine, in order to guarantee complete disinfection of any bacteria, without the need to apply chemicals that could alter the properties of the final product.

Optionally, a second drying may be carried out, for which the seed is fed into the furnace, it is placed for a period of 30 minutes until it reaches a temperature of 160° C., when reaching this point, the seed is kept in the furnace at the same temperature for an additional 9 minutes.

It is important to note that the milling process is not successful if the seed is not properly dehydrated at its exact point in the self-design moisture extracting furnace. A small variation in the dehydration process affects the result of the concentrate or prevents it from being carried out.

If the seed does not have the exact dehydration point, the mill will not be able to process it and prepare the concentrate. If the seed is left in the furnace for longer than the specified time, it becomes bitter and the excess heat may change its nutritional values.

Optionally, the milling process can be repeated. This double high-speed milling step ensures a higher nutrient extraction.

A colloid mill is used for the milling step, which works with a capacity of 1,500 to 4,500 rpm, such mill has a water cooling system so that the pumpkin seed does not heat up and does not alter its color, flavor and nutritional values.

After the seed has been disinfected in the UV machine, it is gradually introduced into the high-speed colloid mill. When the seed enters the colloid mill, the essential oils of the pumpkin seed are extracted by friction, these oils fulfill in this milling process the function of lubricating the mixture, by precipitating and helping all the fiber and other components of the pumpkin seed to be milled and mixed, thereby forming a uniform medium viscosity concentrate with the own color of the pumpkin seed. Additionally, the milling speed to which the seed is exposed guarantees the maximum use of its benefits, without generating surpluses or waste. Subsequently, the concentrate is packed through a completely aseptic vacuum packaging process, which avoids any type of contaminant and provides the perfect storage for the product.

The formulation and mixing step consists of mixing the concentrate with water, it does not require flavorings, colorants, or additional additives. In the preferred embodiment, a ratio of 50 to 75 g of concentrate is used for every 946 mL of water. This mixture is carried out at a speed between 1,500 and 4,500 rpm, from which the pumpkin seed beverage ready for packaging is obtained, through an aseptic process, to guarantee stability, freshness, product quality and correct storage.

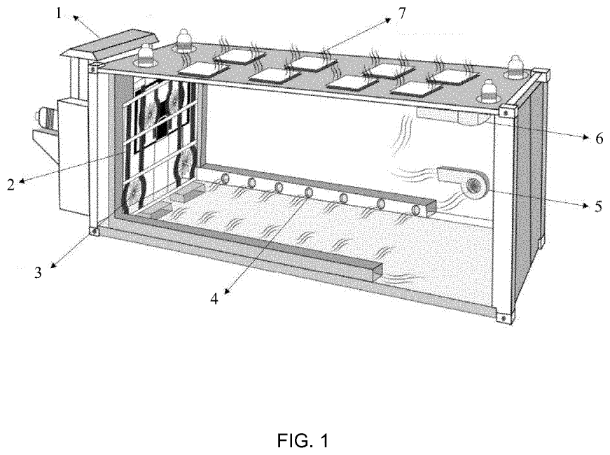

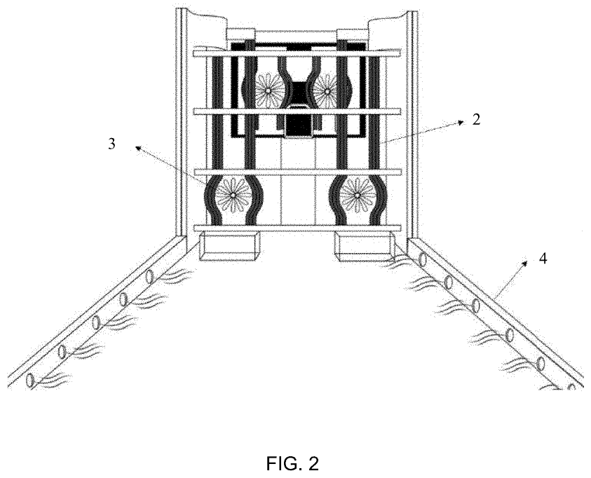

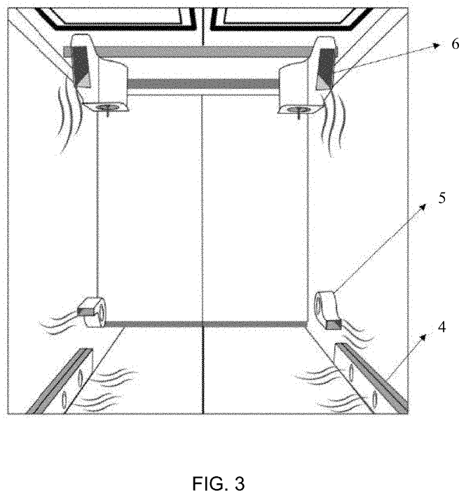

In a second aspect of the present invention, a moisture extracting furnace is provided, which is illustrated in FIGS. 1 to 3. This self-design furnace is made up of a gas burner chimney 1, a system of radiant tubes 2 that allow the furnace to have low gas consumption, a ventilation system comprising fans 3 located on the rear wall of the furnace, heat dispensing tubes distributed along the lower portion of the furnace. The radiant tubes 2, along with the fans 3 and the heat dispensing tubes 4, allow a homogeneous heat dispersion throughout the internal body of the furnace. Additionally, the furnace comprises a system of vanes 5 and 6 for retaining heat in the lower portion of the furnace and a system of moisture extractors 7 located in the upper portion thereof. With this configuration, the optimal dehydration point of the seed is reached, allowing the extraction of moisture without modifying the organoleptic properties of the seed, keeping all the nutrients. Likewise, at the end of the dehydration step, a seed with the adequate moisture content is obtained to make the milling step easier and more efficient.

In a third aspect of the present invention, there is provided a colloid mill made up of a feeding hopper 10, a motor 11 with its motor shaft 12, an acorn nut 13, a gap adjuster 14, a handle 15, a passive mill plate 16, an active mill plate 17, a cooling system 18, airtight covers 19 and 20, a concentrate dispenser 21, and a base 22.

The mill is designed to work with a capacity between 1,500 to 4,500 rpm, and has a water cooling system 18 so that the pumpkin seed does not heat up such that its color, flavor and nutrients are not altered.

### EXAMPLES

An Example is included below for the sole purpose of illustrating the present invention, without implying any limitation on its scope.

### Example 1. Pumpkin Seed Beverage Preparation Process

1. Raw Material Reception

a. RAW MATERIAL ENTRY: Pumpkin seed is received in the raw material reception area; it must go through qualitative analysis controls to determine the quality of the raw material to be received.

b. WEIGHING: The weight of the raw material that is entering is verified and it is transferred to the raw material retention warehouse where the product will remain until the corresponding analyzes are carried out.

c. MOISTURE AND AFLATOXIN ANALYSIS: Samples are collected for each bag to verify the safety of the product. These samples are taken to the laboratory for moisture and aflatoxin analysis. The results must comply with the parameters shown in the following Table 1:

TABLE 1

| | |
|---|---|
| DOES COMPLY | DOES NOT COMPLY |

| MOISTURE | AFLATOXIN | MOISTURE | AFLATOXIN |
|---|---|---|---|
| <12% | <10 PPB | >12% | ≥10 PPB |

If the results do not comply with the indicated parameters, the batch of raw material is rejected, if the results comply with the parameters, the product is stored.

d. STORAGE: The product is stored in the raw material warehouse.

2. Seed Sorting

a. SEED RECEPTION: The product is dispatched from the raw material warehouse and is transferred to the seed sorting processing area.

b. SEED SORTING:
The raw material is gradually and constantly emptied into the feeding hopper of the seed sorting machine, to then be dosed into the vibrating densimetric cylinder, which removes organic matter whose density is greater than that of the raw material itself
A double process of vibrating, blowing and sifting is carried out to finish the separation and removal of the different contaminants.
The raw material, already free of contaminants, is raised to vibrating sieves that separate the pumpkin seed by size and then it is stored in polypropylene bags.

c. WEIGHING: The total of sorted seed and the total of residues or contaminating material are weighed and verified.

d. STORAGE: The product is transferred to the sorted product warehouse.

3. Seed Peeling and Germinating

a. PREPARATION OF THE SOAKING AREA: The water solution with calcium hydroxide (CaOH) at a concentration of between 2.5 to 9.5 g/L is prepared, depending on the pH of the water. The section of the pool with water is filled with a volume of approximately 1,294 liters. The mixture is homogenized with a stirrer and then the pH of the solution that has been prepared is verified, it must have a pH between 9 and 12.

b. SEED RECEPTION: The raw material is dispatched from the sorted product warehouse and is transferred to the soaking area, then the seed is placed in jute bags.

c. SOAKING: The seed is soaked inside the jute bags in the solution prepared with calcium hydroxide. This process is of great importance in order to guarantee the correct extraction of the shell (exocarp or husk), without affecting the green membrane characteristic of the seed. During soaking, calcium hydroxide works as an alkalinizer, removing mineral and organic impurities, and preventing bacterial proliferation. Soaking time ranges from 3 to 15 minutes.

d. DISTILLATION: The bags are removed from the soaking area, followed by distillation.

e. SEED PEELING: The seed is transferred to the peeling area and the product is gradually placed into the feeding hopper of the specialized pumpkin seed peeling machine. By means of the elevator buckets of the machine, the seed is transferred to the peeling blades, separating the seed from the shell, then these fall into a sieve in which the shell is sucked by the separating blower.

f. WEIGHING: The total seed and shell resulting from this process are weighed.

g. GERMINATION: After being peeled, the seed is left germinating for 12 to 24 hours in filtered and purified water with UV, this contributes to enhance the availability of its nutrients.

h. DISTILLATION: The seed is withdrawn from the germination area and it is distilled. It is then placed in stainless steel containers to be transferred to the palletizing and drying process.

4. Technique Specialized in the Dehydration and Milling of the Pumpkin Seed for Preparing the Pumpkin Seed Beverage Concentrate

This proprietary and specialized technique was developed for the successful extraction of all the nutrients from the pumpkin seed and the maximum use thereof, without generating waste. In this technique, the seed goes through a transformation process from which the concentrate of the pumpkin seed beverage is obtained, starting with dehydration until it reaches milling.

4.1. Seed Dehydrating

In this step, the seed is subjected to a drying, dehydration and disinfection process at high temperatures. Proper drying and dehydration are essential to be able to develop the pumpkin seed beverage concentrate.

To achieve the precise result in the seed, a moisture extracting furnace was designed and manufactured. This self-design furnace was specially manufactured for the pumpkin seed dehydration process, which allows the seed to reach a moisture range between 1.90% and 5.5%, preferably between 1.90% and 2.15%, without roasting it, without modifying its texture, color, flavor and, especially, its nutrients.

The structure of the furnace is made up of a system of radiant tubes that allow the furnace to have low gas consumption and along with the ventilation system and the heat dispensing tubes, cause a homogeneous heat dispersion throughout the furnace. The furnace also has a system of vanes that retain the heat in the lower portion thereof, and a system of moisture extractors that are located in the upper portion thereof, the combination of both systems causes the exact dehydration point in the seed.

The seed drying/dehydrating process is developed as follows:

a. SEED PALLETIZING: After the seed has been peeled and germinated, it is placed on trays where it is prepared to be fed into the furnace.

b. SEED BAKING: The seed is placed in the moisture extracting furnace and left there for 80 to 150 minutes, until it reaches a temperature of 115° C., then the seed is left at that temperature for an additional 40 minutes. In this step, the seed undergoes a drying, dehydration and disinfection process at high temperatures. The moisture percentage is reduced to preserve its quality and safety of the seed, without modifying its texture, color, flavor and, especially, its nutrients.

c. MOISTURE BALANCE CONTROL: Samples are taken from the baked seed and it is verified that the moisture percentage is between 1.90% and 5.5%.

d. WEIGHING: At the end of the baking process, the seed is reweighed.

4.2. Seed Sorting

a. SORTING BY SORTER MACHINE: After dehydration of the seed, it is placed in the sorter machine, which performs a high-precision sorting in which the seed is completely discarded with aflatoxin, brown and white seeds and any undesirable residue or foreign material that could exist in the seed (lumps, husk and others).

b. WEIGHING: Weigh again to verify the amount of sorted seeds.

4.3. UV Disinfection

After sorting the seed in the sorter machine, the seed is placed in the UV disinfection machine. This phase supplements the entire process that has been developed in the seed, guaranteeing a complete disinfection of any bacteria, without the need to apply additional heat or chemicals, which could alter the final result of the seed.

4.4. Seed Milling and Preparation of the Pumpkin Seed Beverage Concentrate

For the milling process, the seed is gradually introduced to the high-speed colloid mill that works with a capacity of 1,500 to 4,500 rpm, preferably at 3,800 rpm, such mill has a water cooling system so that the pumpkin seed does not heat up or alter its color, flavor and nutritional values.

TABLE 2
Organoleptic Characteristics of the
Pumpkin Seed Beverage Concentrate

| | |
|---|---|
| TEXTURE | UNIFORM, CREAMY, MEDIUM VISCOSITY, IT |
| | DISSOLVES IN WATER BY COMBINING BOTH |
| | COMPONENTS IN A HIGH SPEED MIXER |
| COLOR | GREEN (CHARACTERISTIC OF THE PUMPKIN SEED) |
| ODOR | PUMPKIN SEED |

4.5. Pumpkin Seed Beverage Concentrate Packaging

The concentrate is packed through a completely aseptic vacuum packaging process, which avoids any type of contaminant and provides the perfect storage for the product.

5. Formulation and Mixing the Pumpkin Seed Beverage

The concentrate is mixed with water, equivalent to a portion of 50 to 75 g of concentrate for every 946 mL of water. This mixture is carried out at a speed of 1,500 to 4,500 rpm, from which the pumpkin seed beverage is obtained.

Formulation: 50 to 75 grams of concentrate+946 ML of water

6. Pumpkin Seed Beverage Packaging

The pumpkin seed beverage is packaged through an aseptic process, which guarantees stability, freshness, product quality and correct storage.

The foregoing description is considered illustrative of the principles of the invention. Thus, while certain aspects and embodiments of the invention have been described, these are shown by way of example only and are not intended to limit the scope of the invention. The scope of the claims should not be limited by the exemplary embodiments set forth previously, but the broadest interpretation consistent with the specification as a whole should be given.

What is claimed is:

1. A process for preparing a pumpkin seed based beverage comprising the steps of:
a) sorting a seed used as raw material;
b) peeling and germinating the seed;
c) dehydrating the seed;
d) sorting the dehydrated seed;
e) disinfection;
f) milling the seed and preparing a concentrate;
g) formulation and mixing the pumpkin seed beverage, free of additives; and
h) packaging the pumpkin seed beverage;
wherein the dehydration step is carried out in a moisture extracting furnace that allows the seed to reach a moisture range between 1.90 and 5.5%.

2. The process according to claim 1, wherein the step of peeling and germinating the seed comprises soaking the seed for between 3 and 15 minutes in an alkaline aqueous solution, peeling the seed and germinating the seed for 24 hours in purified water.

3. The process according to claim 2, wherein the alkaline aqueous solution is a calcium hydroxide solution at a concentration of 3.16 g/L and having a pH between 10 and 12.

4. The process according to claim 1, wherein the dehydration step comprises the step of feeding the seed into said moisture extracting furnace and leaving it for 2 to 6 hours until it reaches a temperature between 110 and 120° C., keeping the seed at said temperature for an additional 20 to 60 minutes.

5. The process according to claim 1, wherein the disinfection step is carried out by UV disinfection.

6. The process according to claim 1, comprising double milling step.

7. The process according to claim 1, wherein the milling step is carried out using a colloid mill operating with a capacity of 1,500 to 4,500 rpm, preferably 3,800 rpm.

8. The process according to claim 6, wherein the mill comprises a water cooling system.

9. The process according to claim 1, wherein the formulation and mixing step comprises mixing the concentrate obtained from the milling step with water.

10. The process according to claim 1, wherein the formulation is carried out in a ratio of 50 to 70 g of concentrate for every 946 mL of water.

11. A moisture extracting furnace for dehydrating pumpkin seeds for producing a pumpkin seed based beverage according to claim 1, the furnace comprising:
a gas burner chimney;
a system of radiant tubes;
a ventilation system comprising fans located on the rear wall of the furnace;
heat dispensing tubes distributed along the lower portion of the furnace;
a system of vanes for retaining heat in the lower portion of the furnace; and
a system of moisture extractors located in the upper portion thereof.
